(19) United States
(12) Patent Application Publication
(10) Pub. No.: US 2023/0400561 A1
(43) Pub. Date: Dec. 14, 2023

(54) RANGING CONTROLLER, RANGING CONTROL METHOD, RANGING DEVICE, AND NON-TRANSITORY COMPUTER READABLE STORAGE MEDIUM

(71) Applicant: DENSO CORPORATION, Kariya-city (JP)

(72) Inventor: Kazuki KATO, Kariya-city (JP)

(21) Appl. No.: 18/455,733

(22) Filed: Aug. 25, 2023

Related U.S. Application Data
(63) Continuation of application No. PCT/JP2022/005112, filed on Feb. 9, 2022.

(30) Foreign Application Priority Data
Mar. 16, 2021 (JP) 2021-042724
Jan. 18, 2022 (JP) 2022-005954

(51) Int. Cl. G01S 7/497; G01S 17/931; G01S 17/10; G01S 17/89

(52) U.S. Cl. CPC G01S 7/497; G01S 17/931; G01S 17/10; G01S 17/89

(57) ABSTRACT

A ranging controller controls a ranging device to measure a distance to a reflection point by detecting a reflection light reflected from the reflection point to which a scan light is emitted. The ranging device is adapted to a movable object. The ranging controller includes a processor that: determines whether an execution condition for executing a calibration of the ranging device is satisfied; controls the ranging device to execute a calibration mode in a case where the processor determines that the execution condition is satisfied; and executes the calibration based on a ranging result of the ranging device in the calibration mode.

### CROSS REFERENCE TO RELATED APPLICATIONS

The present application is a continuation application of International Patent Application No. PCT/JP2022/005112 filed on Feb. 9, 2022, which designated the U.S. and claims the benefit of priority from Japanese Patent Application No. 2021-042724 filed on Mar. 16, 2021 and Japanese Patent Application No. 2022-005954 filed on Jan. 18, 2022. The entire disclosures of all of the above applications are incorporated herein by reference.

### TECHNICAL FIELD

The present disclosure relates to a ranging controller, a ranging control method, a ranging device, and a non-transitory computer readable storage medium.

### BACKGROUND

A photodetector may detect a light reflected at an object to which the light is projected. The photodetector may set at least one region as an interested region in which an object exists in a light projection range. Additionally, at least one of a light projection condition and an execution condition of a signal processing system for a light projection system that projects the light on the interested region may be set differently at a time of projecting the light to the interested region and at a time of projecting the light to an uninterested region.

### SUMMARY

The present disclosure describes a ranging controller, a ranging control method, a ranging device, and a non-transitory computer readable storage medium, each of which measures a distance to a reflection point by detecting a light reflected from the reflection point to which the light is emitted.

### BRIEF DESCRIPTION OF DRAWINGS

FIG. 1 is a block diagram showing an entire configuration of an image processing device.

FIG. 2 is a diagram showing a unit pixel of a light receiving unit in reflection light detection and background light detection.

FIG. 3 is a diagram showing a difference in pixel density between a distance image and a background light image.

FIG. 4 is a diagram showing an example of a peripheral configuration of a vehicle when executing calibration.

FIG. 5 is a diagram showing a difference between a normal ranging mode and a calibration mode.

FIG. 6 is a flowchart showing an example of a ranging control method executed by the image processing device.

FIG. 7 is a diagram showing a difference between a normal ranging mode and a calibration mode in a second embodiment.

FIG. 8 is a diagram showing a difference between a normal ranging mode and a calibration mode in a third embodiment.

FIG. 9 is a flowchart showing an example of a ranging control method executed by an image processing device in a fourth embodiment.

FIG. 10 is a flowchart showing an example of a ranging control method executed by an image processing device in a fifth embodiment.

FIG. 11 is a flowchart showing an example of a ranging control method executed by an image processing device in a sixth embodiment.

FIG. 12 is a block diagram showing an entire configuration of an image processing device in a seventh embodiment.

FIG. 13 is a flowchart showing an example of a ranging control method performed by the image processing device in the seventh embodiment.

FIG. 14 is a block diagram showing an entire configuration of a LiDAR device in another embodiment.

### DETAILED DESCRIPTION

A ranging device for detecting a reflection light may execute either normal ranging or calibration according to a situation.

According to a first aspect of the present disclosure, a ranging controller is adapted to a movable object to control a ranging device for measuring a distance to a reflection point by detecting a reflection light reflected from the reflection point to which a scan light is emitted. The ranging controller includes a processor. The processor determines whether an execution condition for executing a calibration of the ranging device is satisfied. The processor controls the ranging device to execute a calibration mode in a case where the processor determines that the execution condition is satisfied. The calibration mode is lower in a scan speed of the scan light than a normal ranging mode. The normal ranging mode is executed by the processor in a case where the determination unit determines that the execution condition is not satisfied. to the processor executes the calibration based on a ranging result of the ranging device in the calibration mode.

According to a second aspect of the present disclosure, a ranging control method is executed by a processor to control a ranging device to measure a distance to a reflection point by detecting a reflection light reflected from the reflection point to which a scan light is emitted. The ranging device is adapted to a movable object. The ranging control method includes a determination process, a mode execution process, and a calibration process. The determination process determines whether an execution condition for executing a calibration of the ranging device is satisfied. The mode execution process controls the ranging device to execute a calibration mode in a case where the determination process determines that the execution condition is satisfied. The calibration mode is lower in a scan speed of the scan light than a normal ranging mode. The normal ranging mode is executed by the mode execution process in a case where the determination process determines that the execution condition is not satisfied. The calibration process executes the calibration based on a ranging result of the ranging device in the calibration mode.

According to a third aspect of the present disclosure, a non-transitory computer readable medium stores a computer program including instructions to cause a processor to control a ranging device being adapted to a movable object to measure a distance to a reflection point by detecting a reflection light reflected from the reflection point to which a scan light is emitted. The instructions include a determination process, a mode execution process, and a calibration process. The determination process determines whether an execution condition for executing a calibration of the ranging device is satisfied. The mode execution process controls the ranging device to execute a calibration mode in a case where the determination process determines that the execution condition is satisfied. The calibration mode is lower in a scan speed of the scan light than a normal ranging mode. The normal ranging mode is executed by the mode execution process in a case where the determination process determines that the execution condition is not satisfied. The calibration process executes the calibration based on a ranging result of the ranging device in the calibration mode.

According to a fourth aspect of the present disclosure, a ranging device measures a distance to a reflection point by detecting a reflection light reflected from the reflection point to which a scan light is emitted. The ranging device is adapted to a movable object. The ranging device includes a processor. The processor determines whether an execution condition for executing a calibration of the ranging device is satisfied. The processor controls the ranging device to execute a calibration mode in a case where the processor determines that the execution condition is satisfied. The calibration mode is lower in a scan speed of the scan light than a normal ranging mode. The normal ranging mode is executed by the processor in a case where the determination unit determines that the execution condition is not satisfied. to the processor executes the calibration based on a ranging result of the ranging device in the calibration mode.

According to each of the first to fourth aspects described above, in a case where the execution condition in which the calibration is executable, the calibration mode having a lower scan speed of scanning light is executed, and the calibration is executed based on the ranging result in the calibration mode. Therefore, the amount of information per pixel can be increased through the calibration mode as compared to the normal ranging mode. As a result, since it is possible to execute ranging with higher precision, it is possible to improve the calculation precision and calibration precision of the external parameters calculated based on the ranging result. Therefore, it is possible to execute the control of the ranging device suitable for calibration under a condition where the calibration is executable. It is possible to provide the ranging controller, the ranging control method, and the non-transitory computer readable medium, each of which controls the ranging device according to a situation.

According to a fifth aspect of the present disclosure, a ranging controller is adapted to a movable object to control a ranging device for measuring a distance to a reflection point by detecting a reflection light reflected from the reflection point to which a scan light is emitted. The ranging controller includes a processor. The processor determines whether an execution condition for executing a calibration of the ranging device is satisfied. The processor controls the ranging device to execute a calibration mode in a case where the determination unit determines that the execution condition is satisfied. The calibration mode is higher in a resolution of the distance to the reflection point being than a normal ranging mode. The normal ranging mode is executed by the processor in a case where the processor determines that the execution condition is not satisfied. The processor executes the calibration based on a ranging result of the ranging device in the calibration mode.

According to a sixth aspect of the present disclosure, a ranging control method is executed by a processor to control a ranging device to measure a distance to a reflection point by detecting a reflection light reflected from the reflection point to which a scan light is emitted. The ranging device is adapted to a movable object. The ranging control method includes a determination process, a mode execution process, and a calibration process. The determination process determines whether an execution condition for executing a calibration of the ranging device is satisfied. The mode execution process controls the ranging device to execute a calibration mode in a case where the determination process determines that the execution condition is satisfied. The calibration mode is higher in a resolution of the distance to the reflection point being than a normal ranging mode. The normal ranging mode is executed by the mode execution process in a case where the determination process determines that the execution condition is not satisfied. The calibration process executes the calibration based on a ranging result of the ranging device in the calibration mode.

According to a seventh aspect of the present disclosure, a non-transitory computer readable medium stores a computer program including instructions to cause a processor to control a ranging device being adapted to a movable object to measure a distance to a reflection point by detecting a reflection light reflected from the reflection point to which a scan light is emitted. The instructions include a determination process, a mode execution process, and a calibration process. The determination process determines whether an execution condition for executing a calibration of the ranging device is satisfied. The mode execution process controls the ranging device to execute a calibration mode in a case where the determination process determines that the execution condition is satisfied. The calibration mode is higher in a resolution of the distance to the reflection point being than a normal ranging mode. The normal ranging mode is executed by the mode execution process in a case where the determination process determines that the execution condition is not satisfied. The calibration process executes the calibration based on a ranging result of the ranging device in the calibration mode.

According to an eighth aspect of the present disclosure, a ranging device measures a distance to a reflection point by detecting a reflection light reflected from the reflection point to which a scan light is emitted. The ranging device is adapted to a movable object. The ranging device includes a processor. The processor determines whether an execution condition for executing a calibration is satisfied. The processor controls the ranging device to execute a calibration mode in a case where the determination unit determines that the execution condition is satisfied. The calibration mode is higher in a resolution of the distance to the reflection point being than a normal ranging mode. The normal ranging mode is executed by the processor in a case where the processor determines that the execution condition is not satisfied. The processor executes the calibration based on a ranging result of the ranging device in the calibration mode.

According to each of the fifth to eighth aspects described above, in a case where the execution condition in which the calibration is executable, the calibration mode having an increased resolution of the distance to the reflection point is executed, and the calibration is executed based on the ranging result in the calibration mode. Since the calibration mode can enhance the distance precision at the time of ranging, it is possible to enhance the precision of external parameter calculation and calibration executed based on the ranging result. Therefore, it is possible to execute the control of the ranging device suitable for calibration under a condition where the calibration is executable. It is possible to provide the ranging controller, the ranging control method, and the non-transitory computer readable medium, each of which controls the ranging device according to a situation.

### First Embodiment

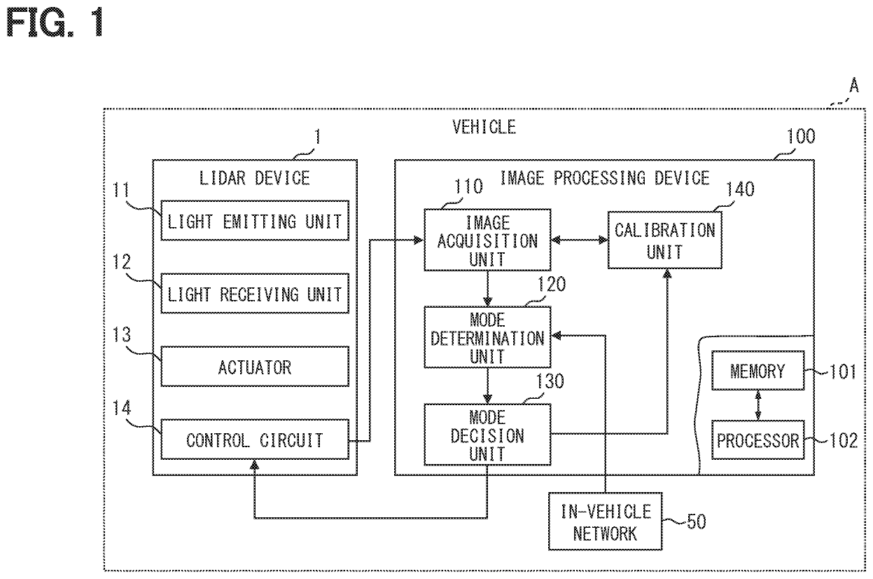

As shown in FIG. 1, an image processing device 100 as a ranging controller according to an embodiment of the present disclosure is adapted to a vehicle A, which is a movable object. The image processing device 100 is an in-vehicle electronic control unit (ECU) that acquires image information from multiple in-vehicle sensors and executes processing such as image recognition. Each of the in-vehicle sensors includes, for example, a light detection and ranging/laser imaging detection and ranging (LiDAR) device 1.

The image processing device 100 can acquire various types of information via an in-vehicle network 50 including at least one of, for example, a local area network (LAN), a wire harness, and an internal bus. The information acquired from the in-vehicle network 50 includes, for example, position information from a locator, map information contained in a map database, behavior information from a behavior sensor of vehicle A, and detection information from other sensors. The behavior sensor includes, for example, a vehicle speed sensor and an attitude sensor.

In addition, the image processing device 100 is connected to the LiDAR device 1 and can communicate with each other. The LiDAR device 1 is a measurement device that measures a distance to a reflection point by detecting light reflected from the reflection point in response to emission of light to the reflection point. The LiDAR device 1 includes a light emitting unit 11, a light receiving unit 12, a mirror, and a control circuit 14.

The light emitting unit 11 is a semiconductor element that emits directional laser light, such as a laser diode. The light emitting unit 11 emits laser light toward an outside of the vehicle A in a form of intermittent pulse beam. The light receiving unit 12 includes a light receiving element having high light sensitivity, such as a single photon avalanche diode (SPAD). The multiple light receiving elements may be arrayed in a two-dimensional direction. A single light receiving pixel (hereinafter simply referred to as a pixel) is formed by a group of adjacent multiple light receiving elements. The number of light-receiving elements forming the single light-receiving pixel can be changed by the control circuit 14. The light receiving unit 12 is exposed to light incident from a sensing region determined by an image capturing angle of the light receiving unit 12 out of an external region of the light receiving unit 12.

An actuator 13 controls a reflection angle of a reflection mirror that reflects the laser light emitted from the light emitting unit 11 to an emission surface of the LiDAR device 1. The laser beam is scanned by controlling the reflection angle of the reflection mirror through the actuator 13. The scanning direction may be a horizontal direction or a vertical direction. The actuator 13 may scan the laser beam by controlling an attitude angle of a housing of the LiDAR device 1.

The control circuit 14 controls the light emitting unit 11, the light receiving unit 12 and the actuator 13. The control circuit 14 is a computer configured to include at least one of a memory and a processor. The memory is at least one type of non-transitory tangible storage medium, such as a semiconductor memory, a magnetic storage medium, and an optical storage medium, for non-transitory storing or memorizing computer readable programs and data. The memory stores various programs executed by the processor.

The control circuit 14 controls exposure and scanning of pixels in the light receiving unit 12, and processes signals from the light receiving unit 12 into data. The control circuit 14 executes two types of photodetection including: reflection light detection in which the reflection light in response to the emission of light from the light emitting unit 11 is detected by the light receiving unit 12; and background light detection in which the background light is detected by the light receiving unit 12 during the stoppage of the emission of light from the light emitting unit 11.

In the reflection light detection, the laser light emitted from the light emitting unit 11 hits an object within the sensing area and is reflected. The reflected portion of the object is a reflection point of the laser light. As a result, the laser light reflected at the reflection point (hereinafter, referred to as reflection light) is incident on the light receiving unit 12 through an incidence surface and is exposed. At this time, the control circuit 14 scans multiple pixels of the light receiving unit 12 to acquire the reflection light at various angles within the field of view. Thereby, the control circuit 14 acquires a distance image of the reflection object being a target object.

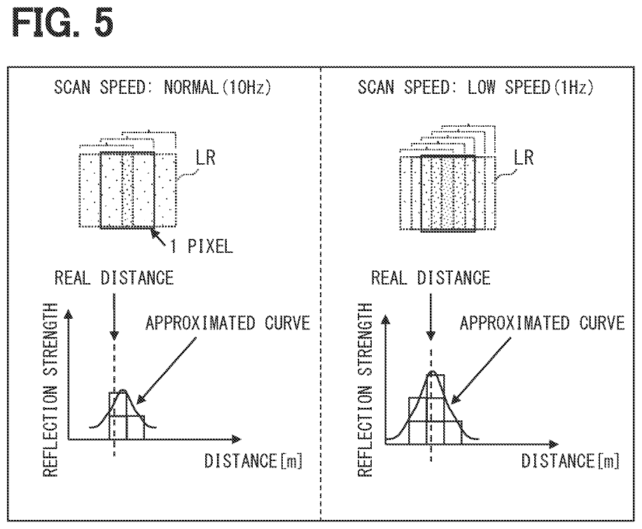

The control circuit 14 calculates the accumulation of the strength of the reflection light acquired by scanning each pixel within a certain time or the accumulation of the distance acquired by a value based on the strength (hereinafter referred to as a reflection strength). Thereby, the control circuit 14 acquires a histogram of distance and reflection intensity as shown in, for example, FIG. 5. The control circuit 14 calculates the distance to the reflection point based on the reflection strength of each bin of the histogram. Specifically, the control circuit 14 generates an approximated curve for bins equal to or greater than a predetermined threshold value, and defines the extreme value of the approximated curve as the distance to the reflection point in that pixel. The control circuit 14 can generate a distance image including distance information for each pixel by performing the above-described processing for all pixels.

On the other hand, in the background light detection, an external light such as sunlight reflects off the object and exposes the light receiving unit 12 while the emission of light from the light emitting unit 11 stops. This exposed light is hereinafter referred to as a background light. At this time, the control circuit 14 scans multiple pixels of the light receiving unit 12 to acquire the background light at various angles within the field of view, as similar to the reflection light. The control circuit 14 can generate a background light image by performing the above-described processing for all pixels. The sensing region of the reflection light and the sensing region of the background light are substantially the same. The background light may also be referred to as the external light or a disturbance light.

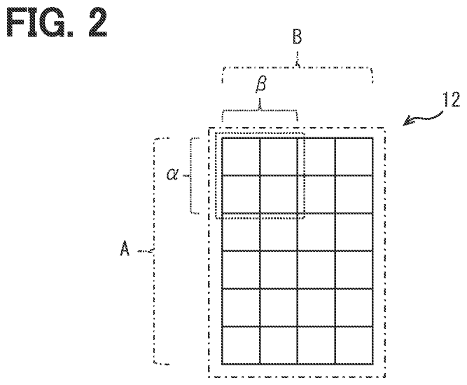

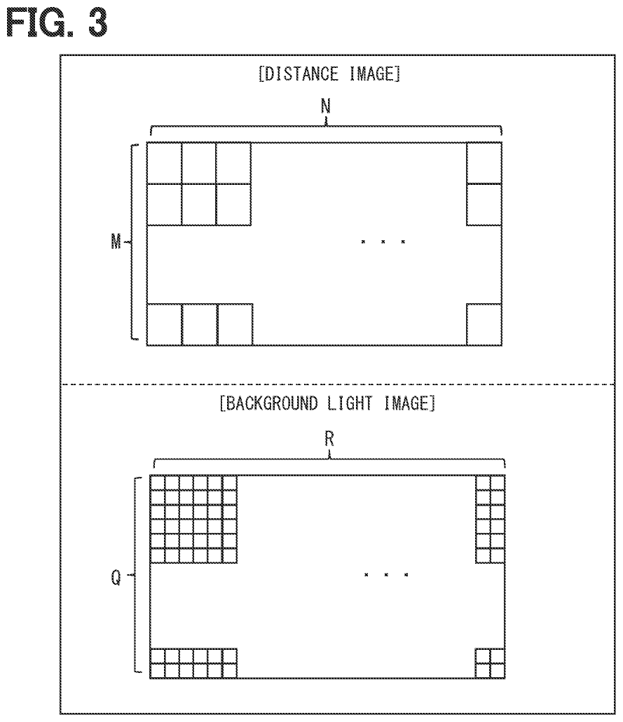

In the present embodiment, the control circuit 14 modifies the size of one pixel depending on whether the reflection light is detected or the background light is detected. As shown in FIG. 2, the control circuit 14 controls the number of light receiving elements (α×β) that form one pixel when the background light is detected to be smaller than the number of light receiving elements (A×B) that form one pixel when the reflection light is detected. As a result, the number of pixels at the time of capturing the background light image is larger than the number of pixels at the time of capturing the distance image. In other words, Q is larger than or equal to M and R is larger than or equal to N as illustrated in FIG. 3. That is, the angular resolution per pixel of the background light image is higher than that of the distance image.

The control circuit 14 can control the scan speed of the light emitting unit 11 and the light receiving frequency of the light receiving unit 12 at both the reflection light detection and the background light detection. The control circuit 14 changes the scan speed by controlling the actuator 13.

The control circuit 14 can execute a normal ranging mode and a calibration mode as ranging modes according to the scan speed. The term “ranging” described in the present disclosure may also be referred to as distance measurement. For example, the normal ranging mode may also be referred to as a normal distance measurement mode, and the ranging mode may be referred to as a distance measurement mode. The calibration mode is a ranging mode in which the scan speed is slower than the normal ranging mode. The following describes each of the ranging modes.

The image processing device 100 is provided by a computer including at least one memory 101 and at least one processor 102. The memory 101 is at least one type of computer-readable non-transitory tangible storage medium, such as a semiconductor memory, a magnetic medium, an optical medium, for non-transitory storage of computer readable programs and data. The memory 101 stores various programs executed by the processor 102, such as a ranging control program described later.

The processor 102 includes, as a core, at least one type of, for example, a Central Processing Unit (CPU), a Graphics Processing Unit (GPU), and an Reduced Instruction Set Computer (RISC) CPU. The processor 102 executes multiple instructions included in the ranging control program stored in the memory 101. Thereby, the image processing device 100 includes multiple functional units for performing the control processing of the ranging mode executed by the LiDAR device 1. As described above, in the image processing device 100, the program stored in the memory 101 causes the processor 102 to execute the multiple instructions, thereby includes functional units for the ranging control. As shown in FIG. 2, the image processing device 100 includes functional units such as an image acquisition unit 110, a mode determination unit 120, a mode decision unit 130, and a calibration unit 140.

The image acquisition unit 110 acquires the distance image and background light image generated by the control circuit 14 of the LiDAR device 1. The image acquisition unit 110 executes predetermined image processing such as object recognition on each acquired image. The image acquisition unit 110 may transmit each acquired image or each image that has undergone image processing to another ECU.

The mode determination unit 120 determines whether the ranging mode of the LiDAR device 1 should be the normal ranging mode or the calibration mode based on the information acquired from the in-vehicle network 50. Therefore, the mode determination unit 120 determines whether an execution condition for executing calibration is satisfied. The mode determination unit 120 determines execution of the calibration mode when determining that the execution condition is satisfied, and determines execution of the normal ranging mode when determining that the execution condition is not satisfied.

For example, the execution condition is that the vehicle A enters a calibration area where execution of the calibration mode is permitted. The calibration area includes at least one of, for example, a space provided for calibration, a stop where passengers get on and off, a parking space such as a parking lot, and an intersection. The determination as to whether the vehicle A has entered the calibration area may be made based on the current position of the vehicle A according to Global Navigation Satellite system (GNSS) such as GPS.

When the mode determination unit 120 determines that the vehicle A has entered the calibration area, the mode determination unit 120 further determines whether the vehicle A has stopped. The mode determination unit 120 may determine whether the vehicle A has stopped based on the speed information of the vehicle A. As an example, the mode determination unit 120 may determine that the vehicle has stopped when the state in which the speed information is 0 km/h has continued for a predetermined period (for example, 5 seconds). Alternatively, the mode determination unit 120 may execute determination based on the distance image and the background light image acquired by the image acquisition unit 110. For example, the difference between the two images may be calculated based on the distance images acquired at the two most recent times, and it may be determined that the vehicle has stopped if the difference is less than a certain value.

The mode determination unit 120 determines execution of the calibration mode when the vehicle A has entered the calibration area and has stopped.

The mode decision unit 130 switches the ranging mode to be executed by the control circuit 14 based on the execution determination by the mode determination unit 120. The mode decision unit 130 generates a command of switching the ranging mode and transmits the generated command to the control circuit 14, in a case where it is determined to execute a ranging mode different from the previous ranging mode. In the first embodiment, the mode decision unit 130 may simply generate a switching command for switching the ranging mode for the entire range of the sensing area. Accordingly, the mode decision unit 130 causes the LiDAR device 1 to execute one of the ranging modes. The mode decision unit 130 corresponds to a mode execution unit.

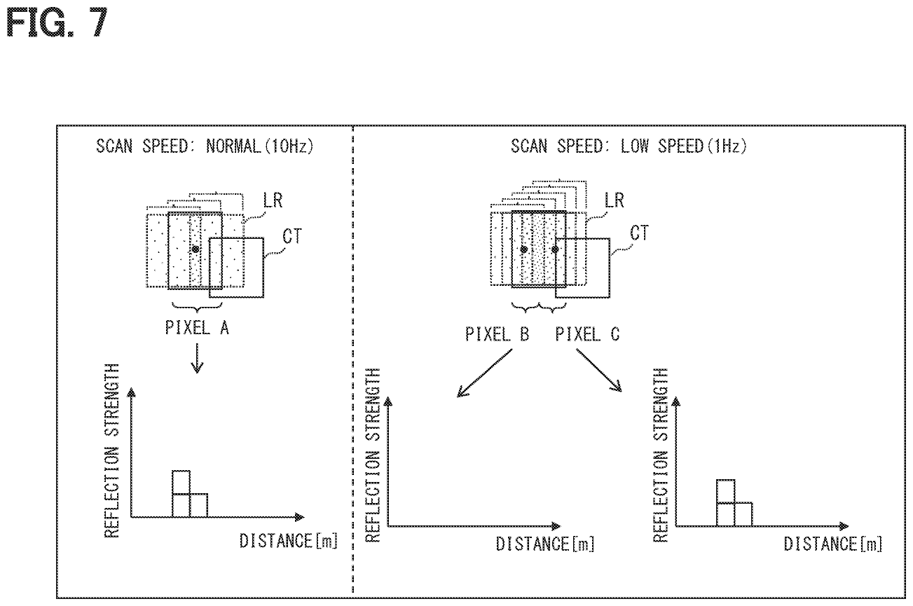

In the calibration mode, the scan speed is set slower than the normal ranging mode. For example, the scan speed in the calibration mode is set to be one tenth of the scan speed in the normal ranging mode, and the scan period of 10 Hz in the normal ranging mode is changed to 1 Hz in the calibration mode. As shown in FIG. 5, the number of light receptions per pixel is greater in the calibration mode than the normal ranging mode. Therefore, the amount of information in the histogram is greater in the calibration mode. This makes the distance to the detected reflection point closer to a real distance, in other words, a true distance. In FIG. 5, multiple rectangles with dotted lines schematically indicate a light receiving range LR for each of multiple light receiving timings. The same applies to FIG. 7, which will be described later.

When the calibration mode is executed, the calibration unit 140 calibrates the LiDAR device 1 based on the distance image and the background light image acquired in the calibration mode.

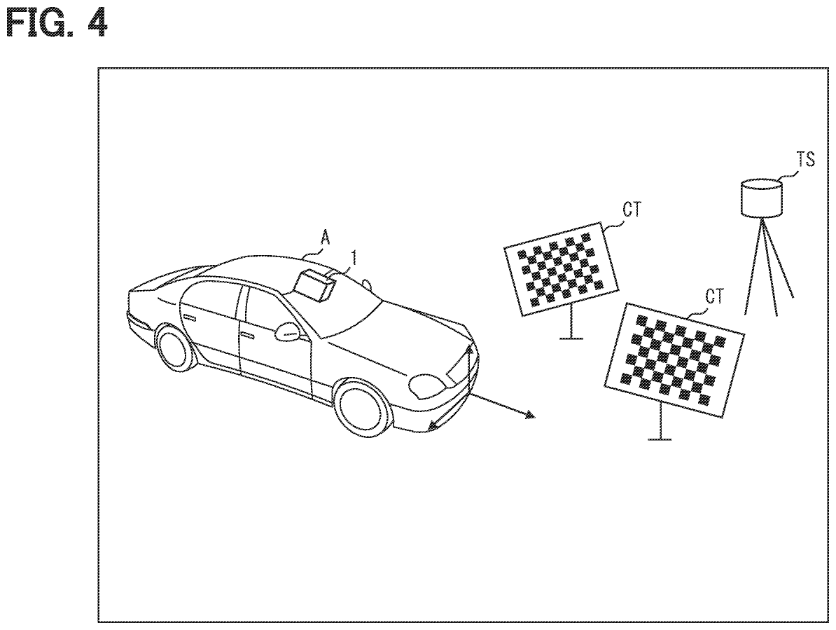

The calibration unit 140 acquires image information acquired in the calibration mode. Furthermore, the calibration unit 140 acquires feature point information of a calibration target CT acquired by sensors other than the LiDAR device. The calibration target CT is, for example, a flat checkerboard as illustrated in FIG. 4. Alternatively, the calibration target CT may be a flat board with any other pattern (for example, a dot pattern). Such a calibration target CT is installed in a previously provided calibration space. Another sensor is, for example, a survey instrument TS installed in the calibration space. The survey instrument TS has a configuration capable of three-dimensional surveying, such as a total station. The survey instrument TS extracts feature points of the calibration target CT and provides the information to the calibration unit 140.

Based on each image obtained by the LiDAR device 1, the calibration unit 140 extracts feature points of the calibration target CT and identifies their three-dimensional coordinates. Specifically, the calibration unit 140 extracts feature points of the calibration target CT from the background light image having a resolution higher than that of the distance image. Then, the calibration unit 140 calculates the coordinates of the distance image corresponding to the coordinates of the extracted feature point of the background light image, and extracts the distance information from each pixel adjacent thereto. The calibration unit 140 converts the extracted distances between adjacent pixels into three-dimensional coordinates, and interpolates the obtained three-dimensional coordinates by bilinear interpolation, bicubic interpolation, or the like, thereby specifying the three-dimensional coordinates of the feature points. Further, the calibration unit 140 acquires information on feature points extracted by other sensors. The calibration unit 140 identifies feature points (corresponding points) by other sensors corresponding to each feature point by the LiDAR device 1, and calculates the posture and position of the LiDAR device 1, that is, external parameters, based on the correspondence among the feature points. The calculated external parameters may be used in image processing in image acquisition unit 110, or may be used in processing using a distance image or background light image in another ECU.

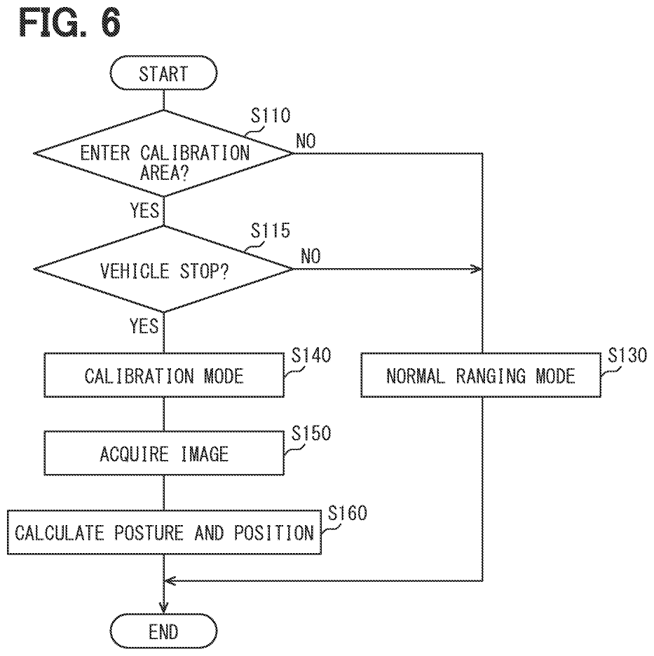

The following will describe a ranging control method executed by the image processing device 100 in cooperation with the functional blocks with reference to FIG. 6. The process of the flowchart described in one or more embodiments of the present disclosure includes multiple sections, and each section is expressed as, for example, S100. Each section may be divided into several subsections, while several sections may be combined into one section. Furthermore, each section thus configured may be referred to as a device, module, or means.

First, in S110, the mode determination unit 120 determines whether the vehicle A has entered the calibration area. In a case where it is determined that the vehicle A entered the calibration area, the mode determination unit 120 determines whether the vehicle A has stopped in S115.

In a case where it is determined at S110 that the vehicle has not entered the calibration area, or if it is determined at S115 that the vehicle A has not stopped, the process proceeds to S130. In S130, the mode decision unit 130 determines the normal ranging mode as the ranging mode. Specifically, if the previous ranging mode was the calibration mode, a command of switching to the normal ranging mode is transmitted in S130. If the previous ranging mode was the normal ranging mode, the ranging mode is maintained in S130.

On the other hand, in a case where it is determined that the vehicle A has stopped in S115, the process proceeds to S140. In S140, the mode decision unit 130 determines the ranging mode to be the calibration mode. Specifically, if the previous distance measurement mode was the normal ranging mode, a switching command for the ranging mode is transmitted in S140. If the previous ranging mode was the calibration mode, the ranging mode is maintained in S140.

Next, in S150, the image acquisition unit 110 acquires a distance image and a background light image. In subsequent S160, the calibration unit 140 calculates the posture and position of the LiDAR device 1 based on the distance image and the background light image.

Each of S110 and S115 mentioned above corresponds to a determination process. S140 corresponds to a mode execution process. S160 corresponds to a calibration process.

According to each of the above aspects, in a case where the execution condition in which the calibration is executable, the calibration mode having a lower scan speed of scanning light is executed, and the calibration is executed based on the ranging result in the calibration mode. Therefore, the calibration mode lengthens the data acquisition time per pixel, so that the amount of information can be increased compared to the normal ranging mode. As a result, since it is possible to execute ranging with higher precision, it is possible to enhance the calculation precision and calibration precision of the external parameters calculated based on the ranging result. Therefore, the control of the LiDAR device 1 suitable for calibration can be executed under a condition where the calibration is executable. As described above, it is possible to execute ranging control according to the situation. Furthermore, since the data acquisition time is lengthened, the amount of background light data is also increased. Thus, it is possible to widen the high dynamic range. Therefore, there may be many situations in which the calibration can be performed.

According to the first embodiment, it is determined that the execution condition is satisfied when the vehicle A has entered the calibration area where execution of the calibration mode is permitted. According to the above situation, when the vehicle A equipped with the LiDAR device 1 enters the calibration area, the calibration can be reliably executed.

### Second Embodiment

In a second embodiment, a modification of the image processing device 100 according to the first embodiment will be described. In FIG. 7, components denoted by the same reference numerals as those in the drawings of the first embodiment are similar components and exhibit the same operation and effects.

In the second embodiment, the mode decision unit 130 changes the number of light receiving elements for obtaining distance information per pixel in the distance image in addition to the scan speed between the normal ranging mode and the calibration mode. Specifically, the mode decision unit 130 reduces the scan speed in the calibration mode and the number of light-receiving elements forming one pixel as compared to normal ranging mode. As a result, the size of one pixel in the calibration mode as a calibration pixel becomes smaller than the size of one pixel in the normal ranging mode as a normal pixel. For example, the mode decision unit 130 defines the size of the calibration pixel so that the number of times of light reception in one scan in one calibration pixel is equal to or greater than the number of times of light reception in one scan in one normal pixel.

As an example, as shown in FIG. 7, the mode decision unit 130 selects the light receiving elements in the calibration mode so that the number of light receptions per pixel is identical in the calibration mode and the normal ranging mode. For example, FIG. 7 illustrates that light reception has been executed three times. Specifically, when the scan speed in the normal mode is 10 Hz and the scan speed in the calibration mode is 1 Hz, the mode decision unit 130 sets the size of the calibration pixel to half of the size of the normal pixel. Accordingly, by reducing the number of light receiving elements as described above, a distance image with higher angular resolution can be acquired. The black dots in the pixels in FIG. 7 indicate points of interest when the distance information in each pixel is converted into three-dimensional coordinates. According to the above-mentioned second embodiment, in the calibration mode, the amount of information per pixel, which is reduced by reducing the number of light receiving elements, can be set to a level identical to one pixel in the normal ranging mode by lowering the scan speed. As a result, it is possible to reduce the number of light receiving elements while maintaining the amount of information, so that a distance image with higher angular resolution than in the normal ranging mode can be acquired. If a distance image with high angular resolution is acquired, the three-dimensional coordinates of feature points can be acquired with higher precision, so it is possible to enhance the calculation precision and calibration precision of external parameters.

### Third Embodiment

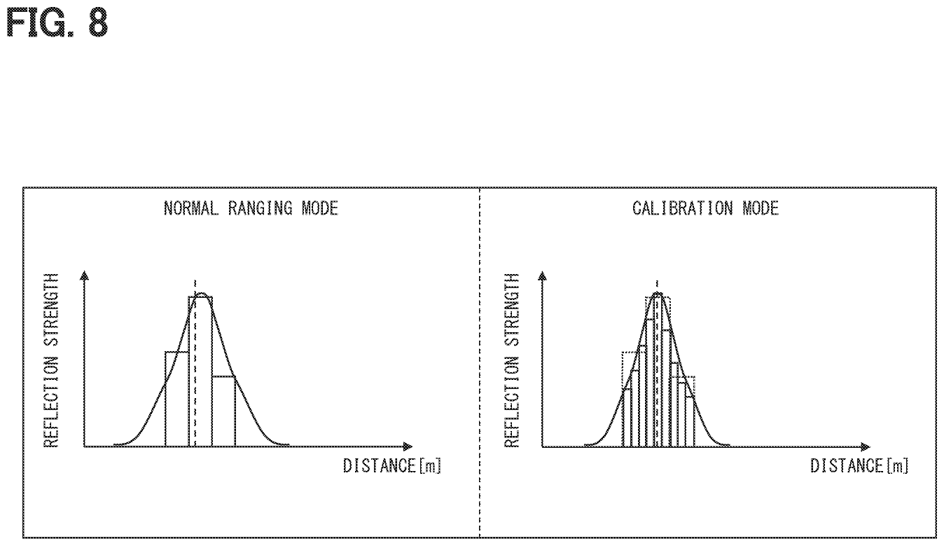

The following will describe a modification of the image processing device 100 according to the first embodiment as a third embodiment. In FIG. 8, components denoted by the same reference numerals as those in the drawings of the first embodiment are similar components and exhibit the same operation and effects.

In the third embodiment, the mode decision unit 130 changes the resolution of the distance to the reflection point between the normal ranging mode and the calibration mode. Specifically, the mode decision unit 130 changes the light receiving frequency of the light receiving unit 12 in the calibration mode, thereby increasing the resolution of the distance corresponding to one bin of the histogram. That is, the mode decision unit 130 sets the received light frequency in the calibration mode to be higher than the received light frequency in the normal ranging mode. For example, the mode decision unit 130 adjusts the received light frequency so that the resolution in the calibration mode is three times the resolution in the normal ranging mode. In other words, the distance range of one bin in the calibration mode is one third of the distance range of one bin in the normal ranging mode.

At this time, the mode decision unit 130 sets the detection distance in the calibration mode to be smaller than the detection distance in the normal ranging mode. Specifically, the mode decision unit 130 sets the detection distance in the calibration mode by multiplying the detection distance in the normal ranging mode by the reciprocal of the multiple of the resolution. By restricting the detection distance, the mode decision unit 130 suppresses an increase in the data amount of the distance image in the calibration mode.

According to the above-mentioned third embodiment, in a case where the execution condition in which the calibration is executable, the calibration mode having an increased resolution of the distance to the reflection point is executed, and the calibration is executed based on the ranging result in the calibration mode. Since the calibration mode can enhance the distance precision during the distance measurement, in other words, ranging, it is possible to enhance the precision of external parameter calculation and calibration performed based on the ranging result. Therefore, the control of the LiDAR device 1 suitable for calibration can be executed under a condition where the calibration is executable. As described above, it may be possible to control the ranging device depending on the situation.

The mode decision unit 130 can enhance the resolution of the distance in the calibration mode and lower the scan speed of the scanning light. In other words, the calibration mode may include both of the enhancement of the resolution of the distance to the reflection point and the setting of the scan speed of the scanning light to be lower than the normal ranging mode. Therefore, it is possible to acquire more accurate calibration.

### Fourth Embodiment

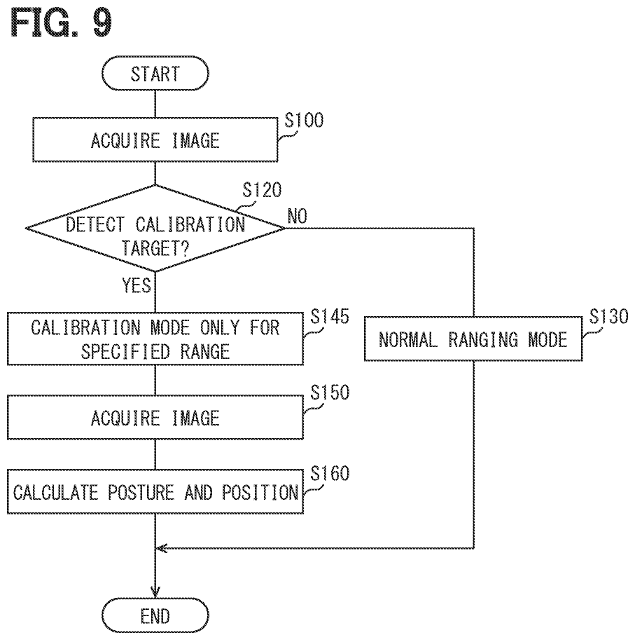

The following describes a modification of the image processing device 100 according to the first embodiment as the fourth embodiment. In FIG. 9, components denoted by the same reference numerals as those in the drawings of the first embodiment are similar components and exhibit the same operation and effects.

In the fourth embodiment, the mode determination unit 120 determines that the execution condition is satisfied in a case where the preliminarily defined calibration target CT exists in the ranging area. The mode determination unit 120 may determine whether the calibration target CT exists based on the image information acquired in the normal ranging mode. For example, the mode determination unit 120 may determine whether an identification marker exists in the preliminarily defined calibration target CT from the distance image or the background light image through image processing.

The mode decision unit 130 decides the ranging, in other words, the distance measurement in the calibration mode for a specified range of the sensing region including the calibration target CT. For example, the mode decision unit 130 may set the orientation range assumed from the position of the detected identification marker as the specified range. In the fourth embodiment, the mode decision unit 130 transmits information about the specified range to the control circuit 14 together with the switching command. The calibration unit 140 executes calibration based on image information in the specified range.

Detailed processing of ranging control method executed by the image processing device 100 in the fourth embodiment will be described below with reference to the flowchart of FIG. 9.

Firstly, in S100, the image acquisition unit 110 acquires image information generated in the normal ranging mode. Next, in S120, the mode determination unit 120 determines whether the calibration target CT is detected. If it is determined that the calibration target CT is not detected, the process shifts to S130. On the other hand, if it is determined that the calibration target CT has been detected, the process proceeds to S145. In S145, the mode decision unit 130 determines execution of the calibration mode only for the specified range including the calibration target CT during scanning. Subsequently, the process shifts to S150, S160.

According to the above-mentioned fourth embodiment, it is determined that the execution condition is satisfied when the preliminarily defined calibration target CT exists within the ranging area. Then, the ranging range, in other words, the distance measurement range in the calibration mode is limited to the specified range within the ranging area including the calibration target CT. When there is a calibration target CT that can be used for calibration, the calibration can be reliably performed. The amount of data can be reduced by limiting the ranging range.

### Fifth Embodiment

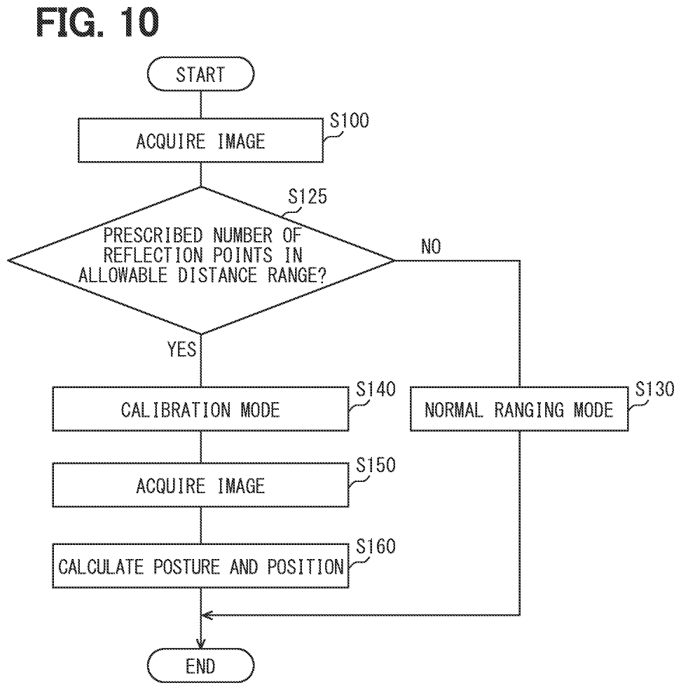

In a fifth embodiment, a modification of the image processing device 100 according to the first embodiment will be described. In FIG. 10, components denoted by the same reference numerals as those in the drawings of the first embodiment are similar components and exhibit the same operation and effects.

In the fifth embodiment, the mode determination unit 120 determines whether a specified number or more of reflection points exist within the allowable distance range based on image information acquired in the normal ranging mode. Here, the allowable distance range is a distance range that is less than or equal to a threshold regarding the distance to the reflection point. As an example, the threshold may be 30 meters (m). Also, as an example, the specified number may be 80% of the total reflection points.

Detailed processing of ranging control method executed by the image processing device 100 in the fifth embodiment will be described below with reference to the flowchart of FIG. 10. As for the same reference numerals as the first or second embodiment, the description in the corresponding embodiment is incorporated.

When the image acquisition unit 110 acquires the image information generated in the normal ranging mode in S100, the process proceeds to S125. In S125, the mode determination unit 120 determines whether a specified number of reflection points exist within the allowable distance range. If it is determined that the specified number of reflection points does not exist, the process proceeds to S130. On the other hand, if it is determined that the specified number of reflection points exist, the process shifts to S140 and continues to S150 and S160.

According to the above-mentioned fifth embodiment, it is determined that the execution condition is satisfied when the number of reflection points whose distance from the vehicle A is within the allowable distance range exceeds a predetermined number. Therefore, a situation in which many calibration targets CT are present at a relatively short distance, that is, a situation suitable for the calibration can be detected, and the calibration can be reliably executed in this situation.

### Sixth Embodiment

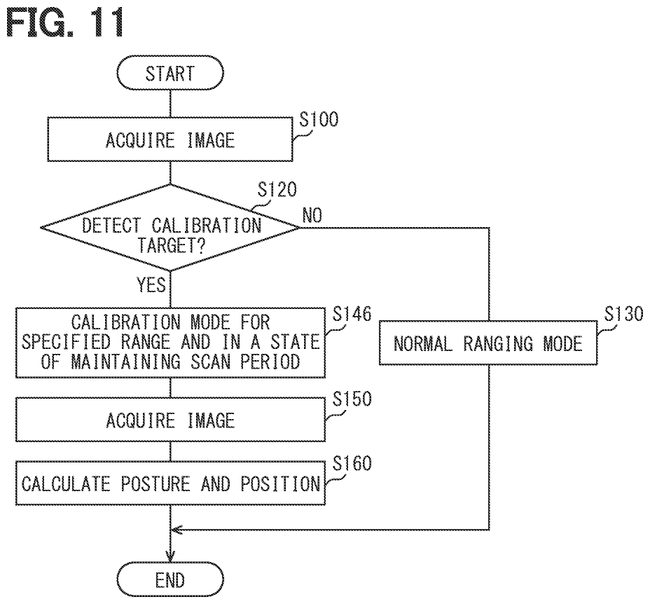

In a sixth embodiment, a modification of the image processing device 100 according to the fourth embodiment will be described. In FIG. 11, components denoted by the same reference numerals as those in the drawings of the first embodiment are similar components and exhibit the same operation and effects.

In the sixth embodiment, the mode determination unit 120 determines that the execution condition is satisfied in a case where the preliminarily defined calibration target CT exists in the ranging area. The mode determination unit 120 may determine whether the calibration target CT exists based on the image information acquired in the normal ranging mode. For example, the mode determination unit 120 may determine whether an identification marker exists in the preliminarily defined calibration target CT from the distance image or the background light image through image processing.

The mode decision unit 130 decides the ranging in the calibration mode for a specified range of the sensing region including the calibration target CT. The mode decision unit 130 sets at least one of the size of the specified range and the scan speed, such that the scan period in the calibration mode (hereinafter referred to as a calibration period) falls within an allowable period range including the scan period in the normal ranging mode (hereinafter referred to as a normal period). The calibration period corresponds to a calibration cycle, and the normal period corresponds to a normal cycle. The allowable period range is, for example, a range in which the calibration period is equal to or greater than a predetermined threshold value. In this case, the threshold value is a value equal to or less than the normal period. It may be desirable to have a smaller difference between the threshold value and the normal period.

As an example, the mode decision unit 130 sets the calibration period to be substantially the same as the normal period. In other words, the mode decision unit 130 maintains the calibration period at the same scan period as the normal period. In a case where the scan speed in the calibration mode is preliminarily defined, the mode decision unit 130 decides the amplitude of the specified range based on the normal period and the scan speed. For example, in a case where the normal period is 10 Hz and the scan speed in the calibration mode is one tenth of the normal mode, the mode decision unit 130 sets the amplitude of the specified range to one tenth of the sensing region. Alternatively, the mode decision unit 130 may set the scan speed based on the amplitude of the preset specified range.

Detailed processing of ranging control method executed by the image processing device 100 in the sixth embodiment will be described below with reference to the flowchart of FIG. 11.

If it is determined in S120 that the calibration target CT has been detected, the flow proceeds to S146. In S146, the mode decision unit 130 decides execution of the calibration mode in a state where the calibration period is maintained to have the same scan period as the normal period for the specified range including the calibration target CT. Subsequently, the process shifts to S150, S160.

According to the sixth embodiment described above, in a case where the ranging range in the calibration mode is limited to the specified range in the ranging area including the calibration target CT, at least one of the amplitude of the specified range and the scan speed is set to fall within the allowable period range including the normal period. Therefore, it is possible to inhibit the delay in the calibration period. In particular, by setting the calibration period to be equal to or greater than the normal period, it is possible to complete the ranging in the calibration mode at a speed equal to or greater than that the normal ranging mode.

### Seventh Embodiment

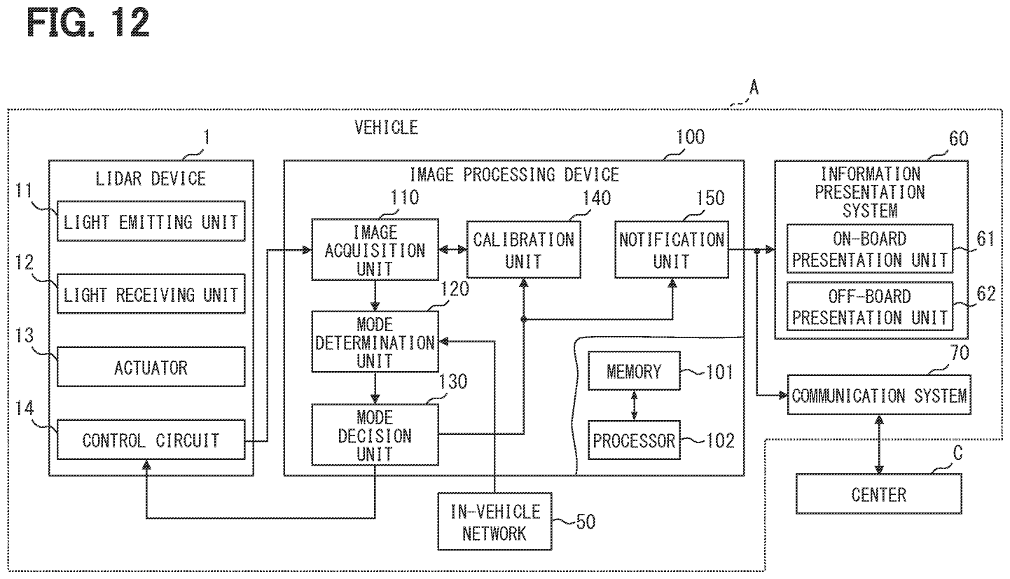

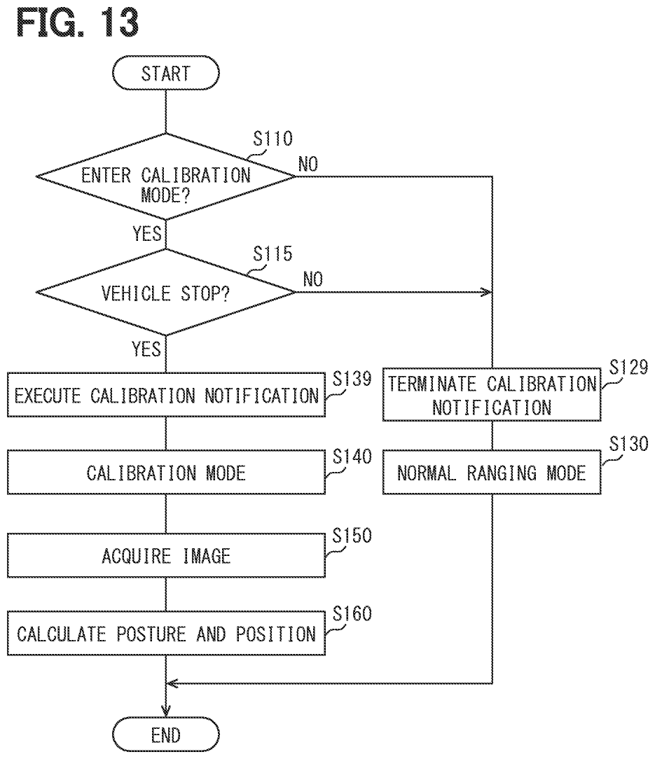

In a seventh embodiment, a modification of the image processing device 100 according to the first embodiment will be described. In FIGS. 12 and 13, components denoted by the same reference symbols as those in the drawings of the first embodiment are similar components and exhibit the same operation and effects.

In the seventh embodiment, the image processing device 100 can communicate with an information presentation system 60 and a communication system 70.

The information presentation system 60 includes an on-board presentation unit 61 that presents notification information to an occupant of the vehicle A. The on-board presentation unit 61 may present notification information by stimulating the occupant's vision. The visual stimulus type information presentation system 60 is at least one type of, for example, a head-up display (HUD), a multi-function display (MFD), a combination meter, a navigation unit, and a light emitting unit. The on-board presentation unit 61 may present notification information by stimulating the occupant's auditory. The auditory stimulation type information presentation system 60 is at least one of, for example, a speaker, a buzzer, and a vibration unit. The on-board presentation unit 61 may present notification information by stimulating the occupant's skin sensation. The skin sensation stimulated by the skin sensation stimulation type on-board presentation unit 61 includes at least one of, for example, haptic stimulus, temperature stimulus, and wind stimulus. The skin sensation stimulus type on-board presentation unit 61 is at least one of, for example, a steering wheel vibration unit, a driver's seat vibration unit, a steering wheel reaction force unit, an accelerator pedal reaction force unit, a brake pedal reaction force unit, and an air conditioning unit.

The information presentation system 60 includes an off-board presentation unit 62 that presents notification information to a person located at the surrounding of the vehicle A. The off-board presentation unit 62 is, for example, at least one type of the visual stimulus type and the auditory stimulation type. The visual stimulation type off-board presentation unit 62 is at least one type of, for example, an indicator light and an vehicular external display. The auditory stimulation type off-board presentation unit 62 is at least one of, for example, a speaker and a buzzer.

The communication system 70 transmits and receives predetermined communication information by wireless communication. The communication system may transmit and receive communication signals with a V2X system existing in the outside of the vehicle A. The V2X type communication system 70 is at least one of, for example, a dedicated short range communications (DSRC) communication device and a cellular V2X (C-V2X) communication device. The vehicle A can communicate with a center C through the communication system 70. The center C has at least a server device for controlling the operation of the vehicle A capable of autonomous driving. The communication system 70 carries out notification to outside of the vehicle A by transmitting communication information to outside, for example, the center C located outside of the vehicle A.

Each of the information presentation system 60 and the communication system 70 corresponds to a notification device. The information presentation system includes, for example, the on-board presentation unit 61 and the off-board presentation unit 62.

In the seventh embodiment, the image processing device 100 further includes a notification unit 150 as a functional unit. The notification unit 150 causes at least one of the on-board presentation unit 61, the off-board presentation unit 62 and the communication system 70 to execute the notification related to the execution of the calibration mode, in other words, the calibration notification. The calibration notification indicates that the ranging mode will be switched between the normal ranging mode and the calibration mode, as an example. In other words, the calibration notification indicates the start of the calibration mode and the end of the calibration mode.

In a case where the on-board presentation unit 61 and the off-board presentation unit 62 are controlled to execute the calibration notification, the notification unit 150 may execute the display of, for example, a message and icon indicating that the calibration mode is being executed during the execution of the calibration mode. The notification unit 150 may cause a display lamp indicating that the calibration mode is being executed to turn off during execution of the calibration mode. The notification unit 150 may output an announcement or notification sound indicating that the calibration mode is being executed to turn off during execution of the calibration mode. By controlling the on-board presentation unit 61 to execute the calibration notification, the notification unit 150 executes the calibration notification to the occupant of the vehicle A as a notified target. By controlling the off-board presentation unit 62 to execute the calibration notification, the notification unit 150 executes the calibration notification to a person around the vehicle A as a notified target.

In a case where the communication system 70 is controlled to execute the calibration notification, the notification unit 150 transmits the information indicating that the calibration mode is being executed to the center C. For example, the notification unit 150 executes the calibration notification by switching the ID indicating the present ranging mode included in the packet of the transmission data to the ID indicating the calibration mode. As a result, the notification unit 150 executes the calibration notification with the server device of the center C or the operator of the center C as the notified target.

Detailed processing of ranging control method executed by the image processing device 100 in the seventh embodiment will be described below with reference to the flowchart of FIG. 13.

In a case where the vehicle A has stopped in S115, the process shifts to S139. In S139, the notification unit 150 executes the calibration notification. In a case where the previous distance measurement mode was the normal ranging mode, the notification unit 150 starts the calibration notification, and in a case where the previous ranging mode was the calibration mode, the notification unit 150 continues the execution of the calibration notification. After executing the process in S139, the process shifts to S140.

If it is determined in S110 that the vehicle A has not entered the calibration area or that the vehicle A has not stopped in S115, the process proceeds to S129. In S129, the notification unit 150 executes a termination process of the calibration notification. In other words, if the previous ranging mode was the normal ranging mode, the notification unit 150 terminates the execution of the calibration notification. After executing the process in S129, the process shifts to S130. In the above, Each of S129 and S139 corresponds to a notification process.

According to the seventh embodiment described above, the notification related to execution of the calibration mode is executed. The notified target such as the occupant of the vehicle A, the person around the vehicle A and the operator can grasp the situation in which the calibration mode is executed by the LiDAR device 1. This enables the notified target to grasp the present ranging mode being either the calibration mode or the normal ranging mode.

### OTHER EMBODIMENTS

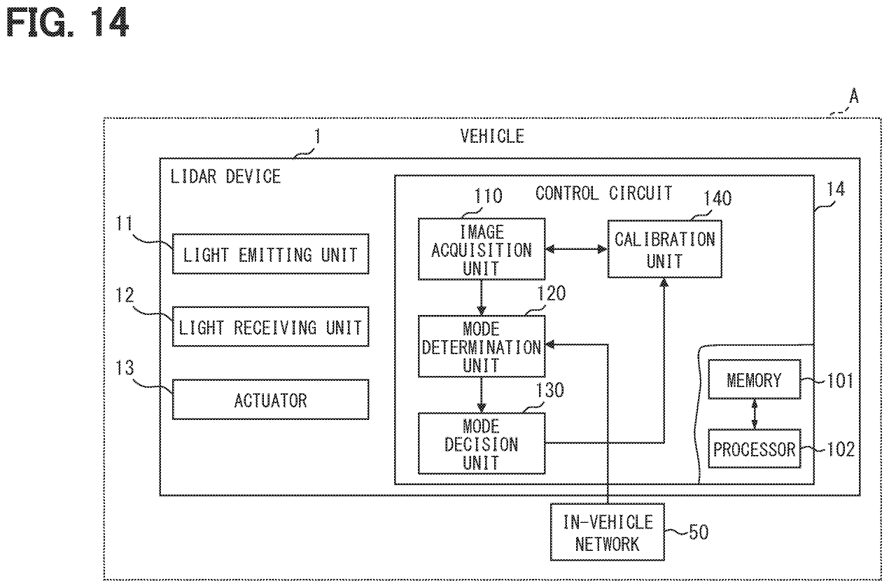

The disclosure in the present specification is not limited to the illustrated embodiments. The disclosure encompasses the illustrated embodiments and modifications based on the embodiments by those skilled in the art. For example, the disclosure is not limited to the parts and/or combinations of elements shown in the embodiments. Disclosure can be implemented in various combinations. The present disclosure may have additional parts that may be added to the embodiments. The present disclosure encompasses modifications in which components and/or elements are omitted from the embodiments. The present disclosure encompasses the replacement or combination of components and/or elements between one embodiment and another. The disclosed technical scope is not limited to the description of the embodiment. The several technical ranges disclosed are indicated by the description of the present disclosure, and should be construed to include all modifications within the meaning and range equivalent to the description of the present disclosure. In the above-described embodiment, the dedicated computer included in the ranging controller provides the image processing device 100. Alternatively, the dedicated computer included in the ranging controller may be the control circuit 14 of the LiDAR device 1 as illustrated in FIG. 14. Alternatively, the dedicated computer included in the ranging controller may be the driving control ECU adapted to the vehicle A, or may be an actuator ECU that individually controls the traveling actuators of the vehicle A. Alternatively, the dedicated computer included in the image processing device 100 may be a locator ECU or a navigation ECU. The dedicated computer included in the image processing device 100 may be an HCU (i.e., Human Machine Interface (HMI) Control Unit) that controls information presentation of the information presentation system. Also, the dedicated computer included in the ranging controller may be a server device provided outside the vehicle A.

Each of the above-mentioned first to seventh embodiments describes whether the mode determination unit 120 satisfies the execution condition. As a modification of the embodiment, the mode determination unit 120 may determine whether at least two of execution conditions are satisfied. In this case, the mode decision unit 130 may decide the execution of the calibration mode when at least one of multiple execution conditions is satisfied. Alternatively, the mode decision unit 130 may determine execution of the calibration mode only when at least two of multiple execution conditions or all determined execution conditions are satisfied.

In the first embodiment described above, the mode determination unit 120 determines to execute the calibration mode when the vehicle A enters the calibration area and stops. Alternatively, in a case where the vehicle A has entered the calibration area, the mode determination unit 120 may determine the execution of the calibration mode regardless of whether the vehicle A stops.

In the above-mentioned embodiment, the calibration target CT is assumed to be installed in a previously provided calibration space. Alternatively, the calibration target CT may be a specific feature existing in the driving environment. Features include, for example, road signs, road markings, and buildings or pillars. In this case, the image processing device 100 may acquire feature point information of the calibration target CT detected by another sensor such as an on-board camera. Alternatively, the image processing device 100 may acquire feature point information related to a feature as the calibration target CT from a three-dimensional map.

In the above-mentioned seventh embodiment, the notification unit 150 notifies the information presentation indicating the switching between the calibration mode and the normal ranging mode as the calibration notification. However, other information presentation may be included in the calibration notification. For example, in a case where the off-board presentation unit 62 executes the information presentation indicating the switching of the ranging mode, the notification unit 150 may execute information presentation indicating the notification of the switching of the ranging mode to a person around the vehicle A as the calibration notification executed in the on-board presentation unit 61. This enables the occupant to understand that the execution of the calibration mode has been notified to the person around the vehicle A. Therefore, it is possible to reduce the occupant's anxiety about the execution of the calibration mode.

The image processing device 100 may be a special purpose computer configured to include at least one of a digital circuit and an analog circuit as a processor. In particular, the digital circuit is at least one type of, for example, an ASIC (Application Specific Integrated Circuit), a FPGA (Field Programmable Gate Array), an SOC (System on a Chip), a PGA (Programmable Gate Array), a CPLD (Complex Programmable Logic Device), and the like. Such a digital circuit may include a memory in which a program is stored.

The image processing device 100 may be a set of computer resources linked by a computer or data communication device. For example, some of the functions provided by the server device 100 in the above-described embodiment may be realized by another ECU or a server device.

What is claimed is:

1. A ranging controller configured to be adapted to a movable object and control a ranging device to measure a distance to a reflection point by detecting a reflection light reflected from the reflection point to which a scan light is emitted, the ranging controller comprising:
a processor configured to:
determine whether an execution condition for executing a calibration of the ranging device is satisfied;
control the ranging device to execute a calibration mode in a case where the processor determines that the execution condition is satisfied, the calibration mode being lower in a scan speed of the scan light than a normal ranging mode or being higher in a resolution of the distance to the reflection point than the normal ranging mode, the normal ranging mode being executed by the processor in a case where the processor determines that the execution condition is not satisfied; and
execute the calibration based on a ranging result of the ranging device in the calibration mode.

2. The ranging controller according to claim 1, wherein the calibration mode is higher in the resolution than the normal ranging mode.

3. The ranging controller according to claim 1, wherein the calibration mode is lower in the scan speed than the normal ranging mode.

4. The ranging controller according to claim 1, wherein the processor is further configured to determine that the execution condition is satisfied in a case where the movable object has entered a calibration area in which execution of the calibration mode is permitted.

5. The ranging controller according to claim 1, wherein
the processor is further configured to:
determine that the execution condition is satisfied in a case where a prescribed calibration target exists in a ranging area;
limit a ranging range of the calibration mode to a specified range within the ranging area, and
the prescribed calibration target exists in the specified range.

6. The ranging controller according to claim 5, wherein the processor is further configured to set at least one of an amplitude of the specified range or the scan speed of the scan light, such that a scan period of the calibration mode is within an allowable period range in which a scan period of the normal ranging mode lies.

7. The ranging controller according to claim 1, wherein
the reflection point includes one or more reflection points having a distance from the movable object within an allowable distance range, and
the processor is further configured to determine that the execution condition is satisfied in a case where number of the reflection points exceeds a predetermined number.

8. The ranging controller according to claim 1, wherein
the ranging device is further configured to acquire a distance image having distance information in each pixel by detecting the reflection light through a plurality of light receiving elements included in each pixel, and
the processor is further configured to execute the calibration mode being smaller in number of the plurality of light receiving elements in each pixel than the normal ranging mode.

9. The ranging controller according to claim 1, wherein the processor is further configured to cause a notification device to execute notification related to execution of the calibration mode.

10. A ranging control method executed by a processor to control a ranging device to measure a distance to a reflection point by detecting a reflection light reflected from the reflection point to which a scan light is emitted, the ranging device configured to be adapted to a movable object, the ranging control method comprising:
a determination process that determines whether an execution condition for executing a calibration of the ranging device is satisfied;
a mode execution process that controls the ranging device to execute a calibration mode in a case where the determination process determines that the execution condition is satisfied, the calibration mode being lower in a scan speed of the scan light than a normal ranging mode or being higher in a resolution of the distance to the reflection point than the normal ranging mode, the normal ranging mode being executed by the mode execution process in a case where the determination process determines that the execution condition is not satisfied; and
a calibration process that executes the calibration based on a ranging result of the ranging device in the calibration mode.

11. The ranging control method according to claim 10, wherein the calibration mode is higher in the resolution being than the normal ranging mode.

12. The ranging control method according to claim 10, wherein the calibration mode further is lower in the scan speed than the normal ranging mode.

13. The ranging control method according to claim 10, wherein the determination process determines that the execution condition is satisfied in a case where the movable object has entered a calibration area in which execution of the calibration mode is permitted.

14. The ranging control method according to claim 10, wherein
the determination process determines that the execution condition is satisfied in a case where a prescribed calibration target exists in a ranging area,
the mode execution process limits a ranging range of the calibration mode to a specified range within the ranging area, and
the prescribed calibration target exists in the specified range.

15. The ranging control method according to claim 14, the mode execution process sets at least one of an amplitude of the specified range or the scan speed of the scan light, such that a scan period of the calibration mode is within an allowable period range in which a scan period of the normal ranging mode lies.

16. The ranging control method according to claim 10, wherein
the reflection point includes one or more reflection points having a distance from the movable object within an allowable distance range, and
the determination process determines that the execution condition is satisfied in a case where number of the reflection points exceeds a predetermined number.

17. The ranging control method according to claim 10, wherein
the ranging device is further configured to acquire a distance image having distance information in each pixel by detecting the reflection light through a plurality of light receiving elements included in each pixel, and
the mode execution process controls the ranging device to execute the calibration mode being smaller in number of the plurality of light receiving elements in each pixel than the normal ranging mode.

18. The ranging control method according to claim 10, further comprising:
a notification process that controls a notification device to execute notification related to execution of the calibration mode.

19. A non-transitory computer readable medium storing a computer program comprising instructions configured to, when executed by a processor to control a ranging device being adapted to a movable object to measure a distance to a reflection point by detecting a reflection light reflected from the reflection point to which a scan light is emitted, cause the processor to execute:
a determination process that determines whether an execution condition for executing a calibration of the ranging device is satisfied;
a mode execution process that controls the ranging device to execute a calibration mode in a case where the determination process determines that the execution condition is satisfied, the calibration mode being lower in a scan speed of the scan light than a normal ranging mode or being higher in a resolution of the distance to the reflection point than the normal ranging mode, the normal ranging mode being executed by the mode execution process in a case where the determination process determines that the execution condition is not satisfied; and
a calibration process that executes the calibration based on a ranging result of the ranging device in the calibration mode.

20. The transitory computer readable medium according to claim 19, wherein the calibration mode is higher in the resolution than the normal ranging mode.

21. A ranging device configured to measure a distance to a reflection point by detecting a reflection light reflected from the reflection point to which a scan light is emitted and further configured to be adapted to a movable object, the ranging device comprising:
a processor configured to
determine whether an execution condition for executing a calibration is satisfied,
control the ranging device to execute a calibration mode in a case where the processor determines that the execution condition is satisfied, the calibration mode being lower in a scan speed of the scan light than a normal ranging mode or being higher in a resolution of the distance to the reflection point than the normal ranging mode, the normal ranging mode being executed by the processor in a case where the processor determines that the execution condition is not satisfied, and
execute the calibration based on a ranging result of the ranging device in the calibration mode.

22. The ranging device according to claim 21, wherein the calibration mode is higher in the resolution than the normal ranging mode.

23. The non-transitory computer readable medium according to claim 19, wherein the calibration mode is lower in the scan speed than the normal ranging mode.

24. The ranging device according to claim 21, wherein the calibration mode is lower in the scan speed than the normal ranging mode.
